(19) United States
(12) Patent Application Publication
(10) Pub. No.: US 2026/0241972 A1
(43) Pub. Date: Aug. 20, 2026

(54) LIMITING DEVICE AND CHILD CARRIER

(71) Applicant: Wonderland Switzerland AG, Steinhausen (CH)

(72) Inventors: ErXue WANG, Guangdong (CN); Mingxing SUN, Guangdong (CN)

(73) Assignee: Wonderland Switzerland AG, Steinhausen (CH)

(21) Appl. No.: 19/532,043

(22) Filed: Feb. 6, 2026

(30) Foreign Application Priority Data
Feb. 19, 2025 (CN) 202510186249.4

(51) Int. Cl. B62B 7/06; B62B 9/10

(52) U.S. Cl. CPC B62B 7/064; B62B 9/102; B62B 2205/20

(57) ABSTRACT

A limiting device and a child carrier are provided. The child carrier includes a backrest frame, a seat frame, and a limiting device. The backrest frame and the seat frame are pivotally connected through a first pivoting portion, so that the backrest frame is pivotable and foldable relative to the seat frame. The limiting device includes a first engaging portion provided on an inner surface of a connecting member of the child carrier facing the first pivoting portion or provided on an inner surface of a frame facing the first pivoting portion, and a second engaging portion provided on an outer surface of the seat frame facing the first pivoting portion. When the backrest frame is pivotally folded relative to the seat frame, the first engaging portion and the second engaging portion are engaged with each other to limit movement of the child carrier.

### CROSS-REFERENCE TO RELATED APPLICATIONS

This application claims priority to Chinese Application No. 2025101862494, entitled “Limiting Device and Child Carrier” and filed on Feb. 19, 2025, which is incorporated herein by reference in its entirety

### TECHNICAL FIELD

The present disclosure relates to a limiting device and a child carrier, and more particularly to a limiting device of a child carrier for preventing the child carrier from loosening and shaking after the child carrier is folded.

### BACKGROUND

A child carrier may be placed on a frame of a child stroller to be used as a child stroller or a child sleep box, and may also be placed on a vehicle seat to be used as a child safety seat, so as to provide safety protection and better comfort for infants and young children in different occasions.

In order to facilitate transportation and temporary storage, the child carrier is generally foldable to reduce a volume thereof. However, existing child carriers are prone to loosening and shaking after being folded.

### SUMMARY

An objective of the present disclosure is to provide a limiting device and a child carrier for limiting movement of the child carrier after being folded.

According to one aspect of the present disclosure, there is provided a child carrier. The child carrier includes a backrest frame, a seat frame, and a limiting device. The seat frame is pivotally connected with the backrest frame through a first pivoting portion, so that the backrest frame is pivotable and foldable relative to the seat frame. The limiting device includes a first engaging portion provided on an inner surface of a connecting member of the child carrier facing the first pivoting portion or provided on an inner surface of a frame facing the first pivoting portion, and a second engaging portion provided on an outer surface of the seat frame facing the first pivoting portion. When the backrest frame is pivotally folded relative to the seat frame, the first engaging portion and the second engaging portion are engaged with each other to limit movement of the child carrier.

According to one embodiment, one of the first engaging portion and the second engaging portion is a protruding structure.

According to one embodiment, the other of the first engaging portion and the second engaging portion is a recessed structure or the inner surface or the outer surface for cooperation.

According to one embodiment, the protruding structure is an elastic body.

According to one embodiment, at least one of the first engaging portion or the second engaging portion is coated with an anti-slip layer.

According to one embodiment, the anti-slip layer is coated on a part or all of the inner surface and/or a part or all of the outer surface.

According to one embodiment, the child carrier further includes a first mounting base connected to an outer side of the first pivoting portion. The child carrier is detachably connected to the frame through the first mounting base. The connecting member is the first mounting base or a connecting part of the backrest frame connected to the first pivoting portion. The first engaging portion of the limiting device is provided on an inner surface of the first mounting base facing the first pivoting portion or provided on an inner surface of the connecting part of the backrest frame facing the first pivoting portion.

According to one embodiment, the first engaging portion is a triggering member, and when the backrest frame is pivotally folded relative to the seat frame, an action of the triggering member is triggered to unlock a child stroller frame, so that the child stroller frame is foldable.

According to one embodiment, the second engaging portion is a recessed structure or a through hole.

According to one embodiment, the first engaging portion is a telescopic protruding structure.

According to another aspect of the present disclosure, there is provided a limiting device for limiting movement of a first component and a second component after being folded relative to each other. The limiting device includes a first engaging portion provided on a surface of the first component facing the second component, and a second engaging portion provided on a surface of the second component facing the first component. After the first component is folded relative to the second component, the first engaging portion and the second engaging portion are engaged with each other to limit the movement of the first component and the second component after being folded. One of the first engaging portion and the second engaging portion is a protruding structure, and the other of the first engaging portion and the second engaging portion is a recessed structure or a surface facing the protruding structure.

According to the present disclosure, since the child carrier is provided with the limiting device, the child carrier can be prevented from loosening and shaking after being folded; meanwhile, the limiting device of the child carrier according to the present disclosure has a simple structure and is easy to process.

### BRIEF DESCRIPTION OF THE DRAWINGS

The drawings are included herein to provide a further understanding of the present disclosure, and are incorporated into and constitute a part of this specification, the drawings illustrate embodiments of the present disclosure, and together with the following description serve to explain concepts of the present disclosure.

In the drawings,

FIG. 1 is a schematic view illustrating a child carrier installed on a child stroller frame according to the present disclosure;

FIG. 2 is a schematic view illustrating the child carrier detached from the child stroller frame according to the present disclosure;

FIG. 3 is a schematic view illustrating a folded state of the child carrier according to the present disclosure;

FIG. 4 and FIG. 5 are schematic views illustrating a limiting device of the child carrier according to the present disclosure;

FIG. 6 is a schematic view illustrating the child carrier in a completely folded state according to the present disclosure;

FIG. 7 is an enlarged view of part A of FIG. 6;

FIG. 8 is a cross-sectional view taken along line B-B in FIG. 7; and

FIG. 9 is a schematic view illustrating another embodiment of the limiting device of the child carrier according to the present disclosure.

### LIST OF REFERENCE NUMERALS

1: child carrier
11: backrest frame
12: seat frame
121: side bar 121a: outer surface
13: handrail frame
14: canopy frame
15: first pivoting portion
16: first mounting base
161: inner surface
17: triggering member
19: limiting device
191: first engaging portion 192: second engaging portion
2: child stroller frame
21: front leg
22: rear leg
23: handle
25: second pivoting portion
26: second mounting base

### DETAILED DESCRIPTION

In the following, exemplary embodiments will be described in detail with reference to the drawings. Although the present disclosure is susceptible to various modifications and alternative forms, specific embodiments thereof are shown by way of example in the drawings. However, the present disclosure should not be construed as being limited to the embodiments set forth herein, but on the contrary, the present disclosure is to cover all modifications, equivalent solutions, and alternative solutions falling within the spirit and scope of the embodiments.

The child carrier 1 according to the present disclosure may be placed on a frame of a child stroller to be used as a child stroller or a child sleep box, and may also be placed on a vehicle seat to be used as a child safety seat. For convenience of description, the child carrier 1 installed on a child stroller frame 2 is taken as an example for description in the following.

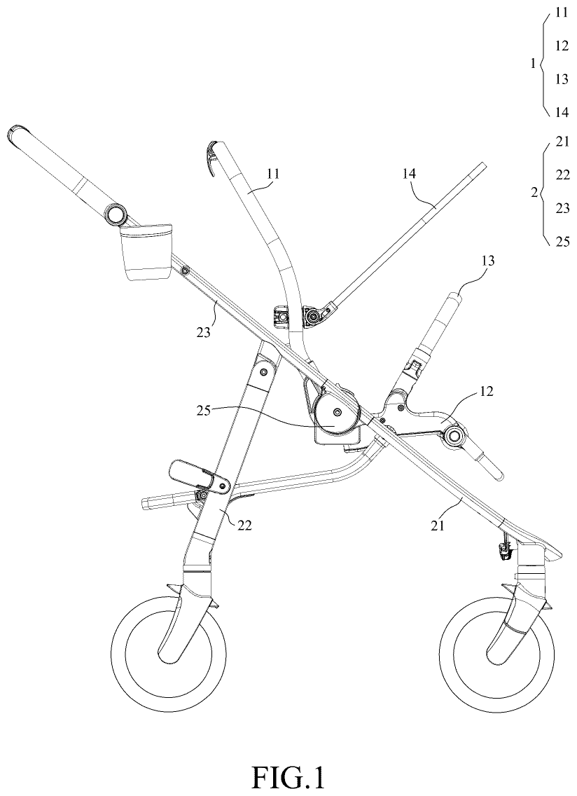

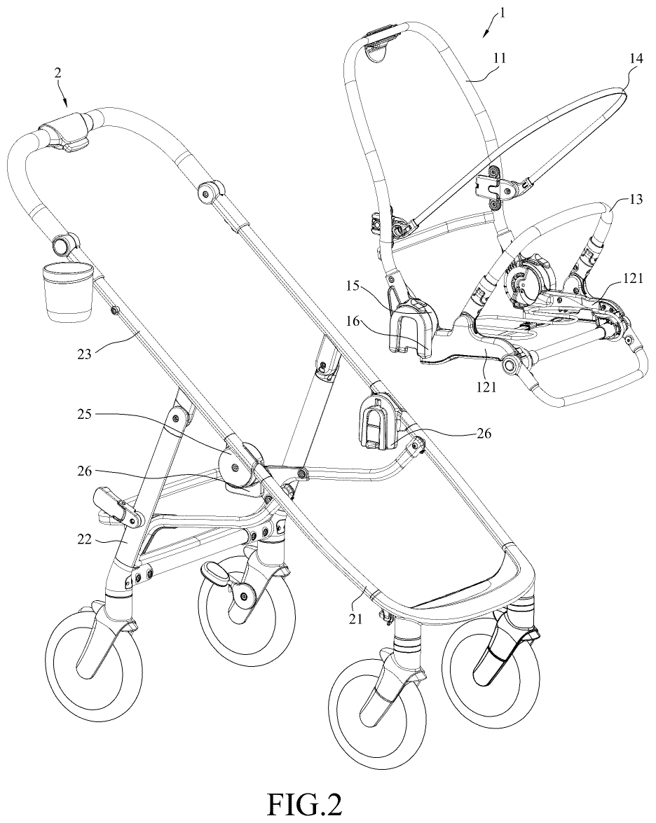

First, referring to FIG. 1 and FIG. 2 of the present disclosure, FIG. 1 illustrates a situation where the child carrier 1 is installed on the child stroller frame 2, and FIG. 2 illustrates a situation where the child carrier 1 is separated from the child stroller frame 2. The child carrier 1 includes a backrest frame 11 and a seat frame 12. The backrest frame 11 and the seat frame 12 are pivotally connected to each other through a first pivoting portion 15, so as to be foldable. The seat frame 12 includes side bars 121 located at two sides thereof. The two side bars 121 of the seat frame 12 are respectively pivotally connected to two ends of the backrest frame 11 through the first pivoting portions 15. In addition, the child carrier 1 may also be provided with a handrail frame 13 and a canopy frame 14 to provide other additional functions. Both the handrail frame 13 and the canopy frame 14 are pivotally connected to the child carrier 1. Therefore, in a folded state of the child carrier 1, both the handrail frame 13 and the canopy frame 14 may be folded.

The child carrier 1 may be installed on the child stroller frame 2, so that the child carrier 1 may be easily pushed. The child stroller frame 2, for example, may include a front leg 21, a rear leg 22, a handle 23, and the like. The front leg 21 and the handle 23 are pivotally connected to each other through a second pivoting portion 25, and the rear leg 22 is also pivotally connected to the handle 23. Therefore, in a folded state of the child stroller frame 2, both the front leg 21 and the rear leg 22 may be folded relative to the handle 23.

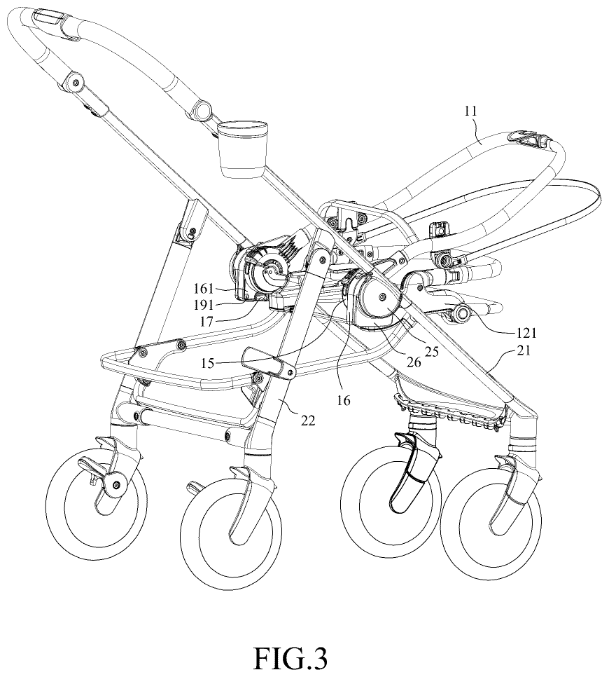

As shown in FIG. 2, in order to install the child carrier 1 on the child stroller frame 2, the child carrier 1 is further provided with a first mounting base 16, with one side facing an occupant as an inner side and one side away from the occupant as an outer side, the first mounting base 16 is provided on an outer side of the first pivoting portion 15. Correspondingly, the child stroller frame 2 is provided with a second mounting base 26, and the second mounting base 26 is provided on an inner side of the second pivoting portion 25. The child carrier 1 may be installed on the child stroller frame 2 through engagement of the first mounting base 16 and the second mounting base 26. As shown in FIG. 3, when the child carrier 1 is installed on the child stroller frame 2, the first pivoting portion 15, the first mounting base 16, the second mounting base 26, and the second pivoting portion 25 are provided from the inner side to the outer side.

According to the embodiment shown in FIG. 3, which illustrates a folded state of the child carrier 1. As described above, the backrest frame 11 of the child carrier 1 may be pivotally folded relative to the seat frame 12. Moreover, a triggering member 17 is provided on an inner surface 161 of the first mounting base 16 of the child carrier 1. When the backrest frame 11 is pivotally folded relative to the seat frame 12, a release of locking between the first pivoting portion 15 and the first mounting base 16 is triggered, so that the folded backrest frame 11 and seat frame 12 as a whole may pivot relative to the first mounting base 16 through the first pivoting portion 15, and the seat frame 12 touches the triggering member 17 during this process, causing the triggering member 17 to act and trigger the release of locking between the second pivoting portion 25 and the second mounting base 26 of the child stroller frame 2, so that the child stroller frame 2 may also be folded synchronously. The specific structure and unlocking process of the triggering member 17 are not the focus of the present disclosure, and similar structures and unlocking principles may refer to, for example, Chinese Patent Application No. 201910313371.8 (Publication No. CN 110386179A).

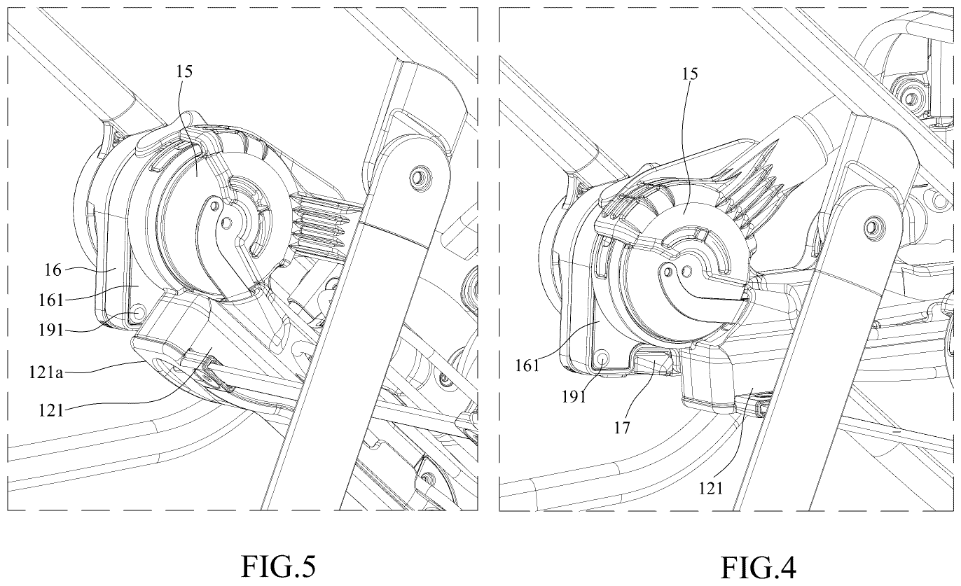

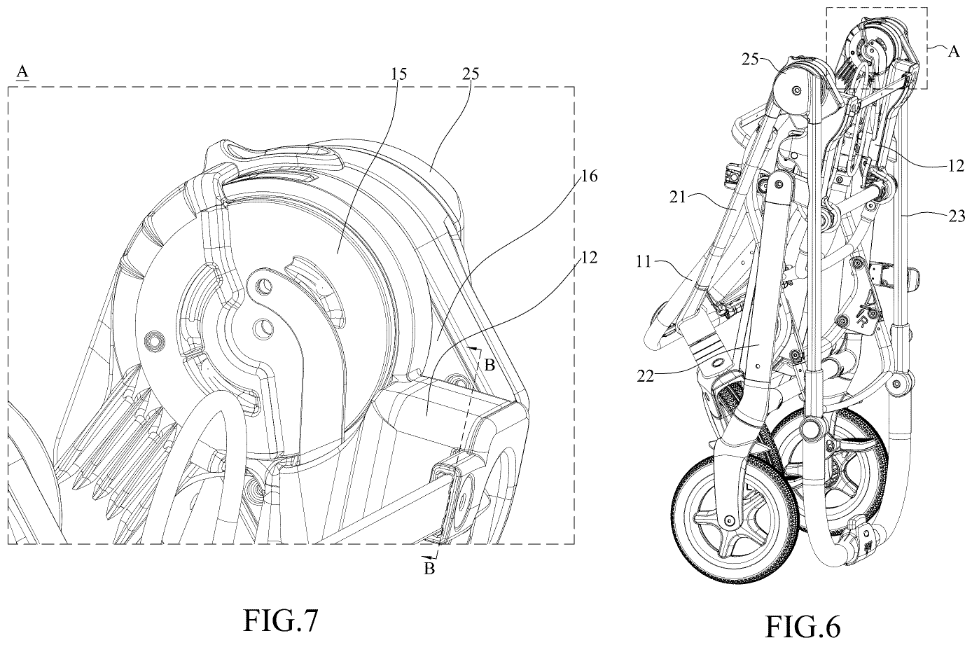

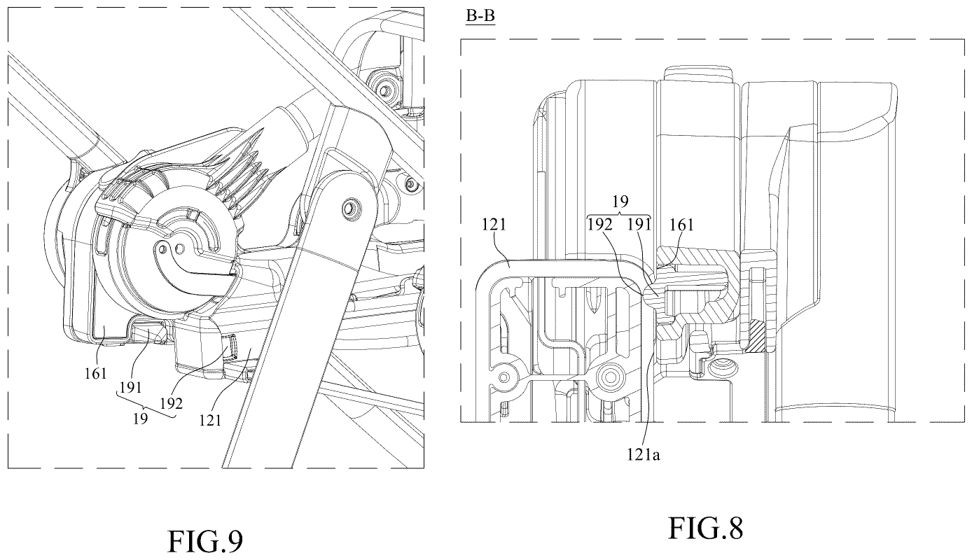

Subsequently, a limiting device 19 according to the present disclosure will be described with reference to FIG. 4 and FIG. 5. The limiting device 19 includes a first engaging portion 191 and a second engaging portion 192 (shown in FIG. 8), still with one side facing an occupant as an inner side and one side away from the occupant as an outer side. The first engaging portion 191 is provided on an inner surface 161 of the first mounting base 16 facing the first pivoting portion 15, and the second engaging portion 192 is provided on an outer surface of the seat frame 12 facing the first pivoting portion. According to one embodiment of the present disclosure, the second engaging portion 192 is provided on an outer surface 121a of the side bar 121. FIG. 4 illustrates a state after the backrest frame 11 of the child carrier 1 is pivotally folded relative to the seat frame 12. As shown in FIG. 5, the folded backrest frame 11 and seat frame 12 as a whole may further pivot relative to the first mounting base 16 through the first pivoting portion 15. During this process, a side bar 121 of the seat frame 12 further pivots relative to the first mounting base 16 along with the first pivoting portion 15, and thus an overlapped area with the first mounting base 16 gradually increases. Finally, the child carrier 1 and the child stroller frame 2 are completely folded. FIG. 6 illustrates a state of the child carrier 1 and the child stroller frame 2 after being completely folded. Referring to the enlarged view of part A of FIG. 7 and the cross-sectional view B-B of FIG. 8 together, during the process where the side bar 121 of the seat frame 12 further pivots relative to the first mounting base 16 along with the first pivoting portion 15, the first engaging portion 191 located on the inner surface 161 of the first mounting base 16 and the second engaging portion 192 located on the outer surface 121a of the side bar 121 of the seat frame 12 are finally engaged with each other, so that loosening and shaking of the child carrier 1 after being folded can be avoided. When it is required to unfold the child carrier 1 again, the engagement of the first engaging portion 191 and the second engaging portion 192 can be forcibly pulled apart.

As shown in FIG. 4, FIG. 5, and FIG. 8, according to one embodiment of the present disclosure, the first engaging portion 191 is in a form of a protruding structure, and the second engaging portion 192 is in a form of a recessed structure, but the present disclosure is not limited thereto, the first engaging portion 191 is in the form of a recessed structure and the second engaging portion 192 is in the form of a protruding structure. The above-mentioned protruding structure may be configured as an elastic body (such as an elastic body formed of rubber, plastic, or other materials with high flexibility and elasticity). In another embodiment, the setting of the recessed structure may also be omitted, and the elastic protruding structure directly abuts against the cooperating inner surface 161 or outer surface 121a. The inner surface 161 and the outer surface 121a are planar.

According to an embodiment not shown, the first engaging portion 191 and the second engaging portion 192 may also be anti-slip layers coated with a material having a large friction coefficient. The anti-slip layer may be coated on a part or all of the inner surface 161 of the first mounting base 16 and a part or all of the outer surface 121a of the side bar 121 of the seat frame 12, that is, the material with a large friction coefficient may be coated only on, for example, the protruding structure of the first engaging portion 191 and/or, for example, the recessed structure of the second engaging portion 192, or may be coated on all areas of the above-mentioned inner surface 161 and outer surface 121a including the first engaging portion 191 and the second engaging portion 192. The anti-slip layer may be only coated on a part or all of the above-mentioned inner surface 161, or may be only coated on a part or all of the above-mentioned outer surface 121a, that is, the anti-slip layer itself may serve as the first engaging portion 191 and/or the second engaging portion 192. The material with a large friction coefficient may be, for example, a rubber-based friction material, a paper-based friction material, or a resin-based friction material. The above-mentioned anti-slip layers, after being engaged with each other, can also achieve an effect of avoiding loosening and shaking of the child carrier 1 after being folded.

Another embodiment of the limiting device 19 according to the present disclosure will be described with reference to FIG. 9. In this embodiment, the first engaging portion 191 is the triggering member 17 (as shown in FIG. 4) mentioned above. The triggering member 17 is provided on the inner surface 161 of the first mounting base 16 of the child carrier 1. After the seat frame 12 of the child carrier 1 is pivotally folded relative to the backrest frame 11, when the seat frame 12 and the backrest frame 11 as a whole further pivot relative to the first mounting base 16 through the first pivoting portion 15, the side bar 121 of the seat frame 12 touches the triggering member 17. Cooperatively therewith, a through hole is provided on the outer surface 121a of the side bar 121 of the seat frame 12. As shown in FIG. 9, the through hole serves as the second engaging portion 192, so that the triggering member 17 serving as the first engaging portion 191 may be engaged in the through hole serving as the second engaging portion 192 during the process of the above-mentioned further pivoting, thereby limiting the movement between the backrest frame 11 and the seat frame 12, so that loosening and shaking of the child carrier 1 after being folded can be avoided. When a user needs to unfold the child carrier 1 again, the user can operate (such as press) the triggering member 17 through the second engaging portion 192 in the form of the through hole to disengage it from the engagement with the second engaging portion 192.

FIG. 9 only schematically illustrates the second engaging portion 192 as a through hole. The through hole may, for example, open from a side end of the side bar 121 of the seat frame 12 facing the ground, and the opening extends to an outer surface of the side bar 121 facing the first mounting base 16, so that the through hole cannot be seen on an opposite inner surface of the side bar 121, thereby improving overall aesthetics of the child carrier 1. The above-mentioned through hole may also be referred to as a hole. FIG. 9 illustrates the second engaging portion 192 in a form of a through hole, but the present disclosure is not limited thereto, the second engaging portion 192 may also be in a form of a recessed structure. When the seat frame 12 is folded relative to the backrest frame 11, the triggering member serving as the first engaging portion 191 may be engaged in the second engaging portion 192 in the form of the recessed structure, which can also achieve the effect of avoiding loosening and shaking. When it is required to unfold the child carrier 1 again, the engagement of the first engaging portion 191 and the second engaging portion 192 may be forcibly pulled apart.

According to this embodiment, an existing component of the child carrier 1 may be utilized to form the first engaging portion 191 to achieve an anti-loosening effect, so that the existing child carrier may be easily modified to form the limiting device 19.

According to other embodiments, as shown in FIG. 3 and FIG. 4, the triggering member 17 and the protruding structure may be utilized simultaneously to form the first engaging portion 191, or the triggering member 17 and the anti-slip layer of a material with a large friction coefficient may also be utilized simultaneously to form the first engaging portion 191, so that better limiting and anti-loosening effects can be achieved.

The above mainly takes a situation where the child carrier 1 is detachably provided on the child stroller frame 2 through cooperation of the first mounting base 16 and the second mounting base 26 as an example, however, the present disclosure is not limited thereto. According to other embodiments of the present disclosure, the child carrier 1 may also be non-detachably provided with the child stroller frame 2, i.e., fixedly connected with the child stroller frame 2. In this case, the first engaging portion 191 may be provided on an inner surface of a connecting member of the child carrier 1 facing the first pivoting portion 15 or provided on an inner surface of the child stroller frame 2 facing the first pivoting portion 15, that is, in a case where the first mounting base 16 is provided, the connecting member is the first mounting base 16 of the child carrier 1, and in a case where the first mounting base 16 is not provided, the connecting member may be a connecting part of the backrest frame 11 connected to the first pivoting portion 15; and the second engaging portion 192 may still be provided on the outer surface 121a of the seat frame 12 facing the first pivoting portion 15, such that when the backrest frame 11 is pivotally folded relative to the seat frame 12, the first engaging portion 191 and the second engaging portion 192 may still be engaged with each other to limit the movement of the child carrier 1.

Certainly, the limiting device 19 according to the present disclosure may also be applied to other devices not limited to the child carrier for limiting movement of a first component and a second component after being folded relative to each other. In this case, the limiting device 19 also includes a first engaging portion 191 and a second engaging portion 192. The first engaging portion 191 is provided on a surface of the first component facing the second component, and the second engaging portion 192 is provided on a surface of the second component facing the first component, such that after the first component is folded relative to the second component, the first engaging portion 191 and the second engaging portion 192 are engaged with each other to limit the movement of the first component and the second component after being folded. The same as the aforementioned embodiments, one of the first engaging portion 191 and the second engaging portion 192 is a protruding structure, and the other of the first engaging portion 191 and the second engaging portion 192 is a recessed structure or a surface facing the protruding structure.

Since features of the present disclosure may be embodied in various forms without departing from characteristics of the present disclosure, it should also be understood that the above-described embodiments are not limited to any details of the foregoing description, unless otherwise specified, but should be interpreted broadly within the scope defined by the appended claims. Therefore, all modifications and variations falling within the scope and boundaries of the claims, or within equivalent solutions of such scope and boundaries, should be covered by the appended claims.

What is claimed is:

1. A child carrier, comprising:
a backrest frame;
a seat frame pivotally connected with the backrest frame through a first pivoting portion, so that the backrest frame is pivotable and foldable relative to the seat frame; and
a limiting device, comprising:
a first engaging portion provided on an inner surface of a connecting member of the child carrier facing the first pivoting portion or provided on an inner surface of a frame facing the first pivoting portion; and
a second engaging portion provided on an outer surface of the seat frame facing the first pivoting portion, wherein when the backrest frame is pivotally folded relative to the seat frame, the first engaging portion and the second engaging portion are engaged with each other to limit movement of the child carrier.

2. The child carrier according to claim 1, wherein one of the first engaging portion and the second engaging portion is a protruding structure.

3. The child carrier according to claim 2, wherein the other of the first engaging portion and the second engaging portion is a recessed structure or the inner surface or the outer surface for cooperation.

4. The child carrier according to claim 2, wherein the protruding structure is an elastic body.

5. The child carrier according to claim 1, wherein at least one of the first engaging portion or the second engaging portion is coated with an anti-slip layer.

6. The child carrier according to claim 1, further comprising:
a first mounting base connected to an outer side of the first pivoting portion, the child carrier being detachably connected to the frame through the first mounting base,
wherein the connecting member is the first mounting base or a connecting part of the backrest frame connected to the first pivoting portion, and
wherein the first engaging portion of the limiting device is provided on an inner surface of the first mounting base facing the first pivoting portion or provided on an inner surface of the connecting part of the backrest frame facing the first pivoting portion.

7. The child carrier according to claim 6, wherein the first engaging portion is a triggering member, and when the backrest frame is pivotally folded relative to the seat frame, the triggering member is triggered to unlock a child stroller frame, so that the child stroller frame is foldable.

8. The child carrier according to claim 7, wherein the second engaging portion is a recessed structure or a through hole.

9. The child carrier according to claim 7, wherein the first engaging portion is a telescopic protruding structure.

10. A limiting device for limiting movement of a first component and a second component after being folded relative to each other, wherein the limiting device comprises:
a first engaging portion provided on a surface of the first component facing the second component; and
a second engaging portion provided on a surface of the second component facing the first component,
wherein after the first component is folded relative to the second component, the first engaging portion and the second engaging portion are engaged with each other to limit the movement of the first component and the second component after being folded, and
wherein one of the first engaging portion and the second engaging portion is a protruding structure, and the other of the first engaging portion and the second engaging portion is a recessed structure or a faced surface.
